(19) United States
(12) Patent Application Publication
(10) Pub. No.: US 2023/0065287 A1
(43) Pub. Date: Mar. 2, 2023

(54) SYSTEMS AND METHODS FOR CONTROLLING A PROGRESSIVE JACKPOT AND DISPLAYED DIGITAL CONTENT

(71) Applicant: Aristocrat Technologies, Inc., Las Vegas, NV (US)

(72) Inventor: Craig Paulsen, Reno, NV (US)

(21) Appl. No.: 17/865,184

(22) Filed: Jul. 14, 2022

Related U.S. Application Data
(60) Provisional application No. 63/240,201, filed on Sep. 2, 2021.

(51) Int. Cl. G07F 17/32; G06Q 30/02; G06Q 20/02; G06V 40/18; G06V 20/52

(52) U.S. Cl. CPC G07F 17/3258; G07F 17/323; G07F 17/3213; G06Q 30/0245; G06Q 20/02; G06V 40/18; G06V 20/52

(57) ABSTRACT

A system that includes a display device, and a processor configured to control the display device to display digital content. The processor further configured to, in response to controlling the display device to display the digital content, increase an incremental value associated with a progressive jackpot from a first incremental amount to a second incremental amount. The processor is also configured to control a progressive meter to display at least one increase of the progressive jackpot by the second incremental amount, such that a running total amount of the progressive jackpot increases more rapidly in response to the digital content being displayed.

### CROSS-REFERENCE TO RELATED APPLICATIONS

This application claims the benefit of priority to U.S. Provisional Patent Application Ser. No. 63/240,201, filed Sep. 2, 2021, and entitled, “SYSTEMS AND METHODS FOR INCREASING A PROGRESSIVE JACKPOT BASED ON DISPLAY OF DIGITAL CONTENT,” the contents and disclosures of which are hereby incorporated by reference in their entirety.

### TECHNICAL FIELD

The field of disclosure relates generally to electronic gaming, and more particularly to electronic gaming systems for controlling a progressive jackpot and the display of digital content, wherein the progressive jackpot may be increased at a higher rate if digital content is displayed during game play.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

At least some known wagering games include progressive jackpots, which may be funded in part by taking a percentage of the credit-in (or a percentage of player wagers) and applying the percentage to the progressive jackpots. After the progressive jackpot is won, the jackpot is set to some basic (initial) level, and every time a player inserts a credit or otherwise makes a wager, a percentage of the wager is determined and provided to the progressive jackpot. Likewise, in some cases, percentage of the wager is provided to a temporary holding fund, which can be used to fund increases to the progressive jackpot as well.

In some cases, if the gaming system determines that the progressive award is not growing at a desired rate (e.g., due to lack of wagers placed on machines contributing to the progressive), the gaming system may utilize all or a part of the amount in the temporary holding fund to make up, at least in part, for the lack of wager-based jackpot growth. Even if players are not actively playing machines associated with the progressive jackpot award, the award may therefore be incremented at some designated rate. Accordingly, to fund the temporary holding fund and/or progressive, and as an example, 3% of play credits may be allocated to the progressive jackpot, and 2% to the temporary holding fund.

One shortcoming of this type of progressive funding can be that players lose interest and excitement over time, such as for example, as a result of slow and/or seemingly plodding growth of the progressive jackpot. In addition, because the progressive increments are in many cases predictable, players may also lose interest and excitement for this reason as well. There is therefore a need to provide for a different type of progressive jackpot funding, such as jackpot funding that provides greater player interest and excitement as well as allowing for rapid and/or uncertain increases in progressive jackpot amounts in an unpredictable manner.

### BRIEF DESCRIPTION

In one aspect, a gaming system is described. The system includes a display device, and a processor configured to control the display device to display digital content. The processor further configured to, in response to controlling the display device to display the digital content, increase an incremental value associated with a progressive jackpot from a first incremental amount to a second incremental amount. The processor is also configured to control a progressive meter to display at least one increase of the progressive jackpot by the second incremental amount, such that a running total amount of the progressive jackpot increases more rapidly in response to the digital content being displayed.

In another aspect, a method for increasing a progressive jackpot is described. The method includes controlling a display device to display digital content, and in response to controlling the display device to display the digital content, increasing an incremental value associated with a progressive jackpot from a first incremental value to a second incremental value. The method also includes controlling a progressive meter to display at least one increase of the progressive jackpot by the second incremental value, such that a running total amount of the progressive jackpot increases more rapidly in response to the digital content being displayed.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a diagram of an example embodiment of a wagering game, in which a plurality of progressive jackpots are shown.

### DETAILED DESCRIPTION

Systems and methods for controlling a progressive jackpot and the display of digital content are described herein. More specifically, the systems and methods described herein are configured to control a rate of increase to a progressive jackpot that a player may be eligible to win based on whether the player agrees to view digital content on a gaming machine, and then control what digital content is then displayed.

In some embodiments, a progressive jackpot may be provided, such as in association with a bank of electronic gaming devices. The progressive jackpot may slowly increase as one or more players at the bank of gaming devices place wagers on respective gaming devices. For example, a first percentage of wagers may be allocated to increasing the jackpot. In some embodiments, the progressive jackpot may be increased, at least some of the time and/or under certain conditions, at a more rapid rate by adjusting or adding to the first percentage of wagers. For example, a second percentage may be added to the first percentage in response to any of a variety of events occurring during gameplay. By varying the rate of increase of the jackpot (e.g., by varying the percentage of the wager contributed to the jackpot) based on one or more conditions separate from the wager itself, a degree unpredictability may added to the jackpot, which may incentivize play.

In at least one embodiment, players may be given an option to view digital content, such as marketing materials, advertisements, coupons, specific offers, podcasts, social media content, videos, audio content, blogs, infographics, E-books and images. Such digital content may be displayed by an electronic gaming device, and/or may be presented the player for viewing in other ways, such as by causing a mobile device associated with the player to display the digital content. In response to viewing the digital content, the second percentage may be added to the first percentage to increase the progressive jackpot at a more rapid rate and/or otherwise more dramatically than the jackpot is incremented in the absence of the digital content being viewed. As a result, players are incentivized to view the digital content and the wagering game is made more exciting, rewarding, and the like.

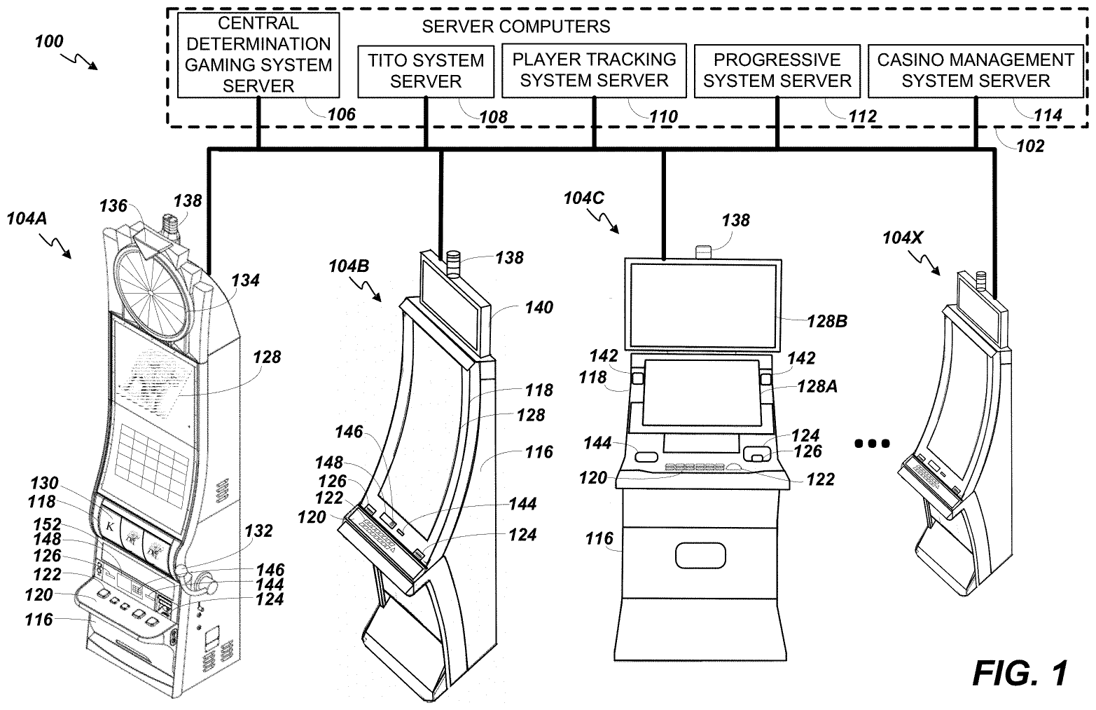

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), near-field communication (NFC), cable TV, satellite links, and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

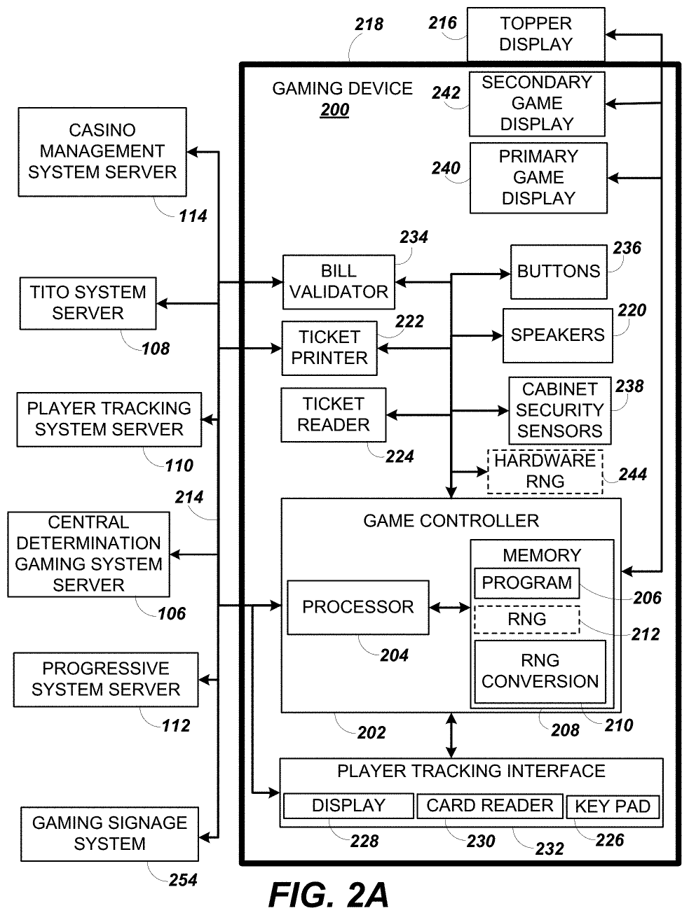

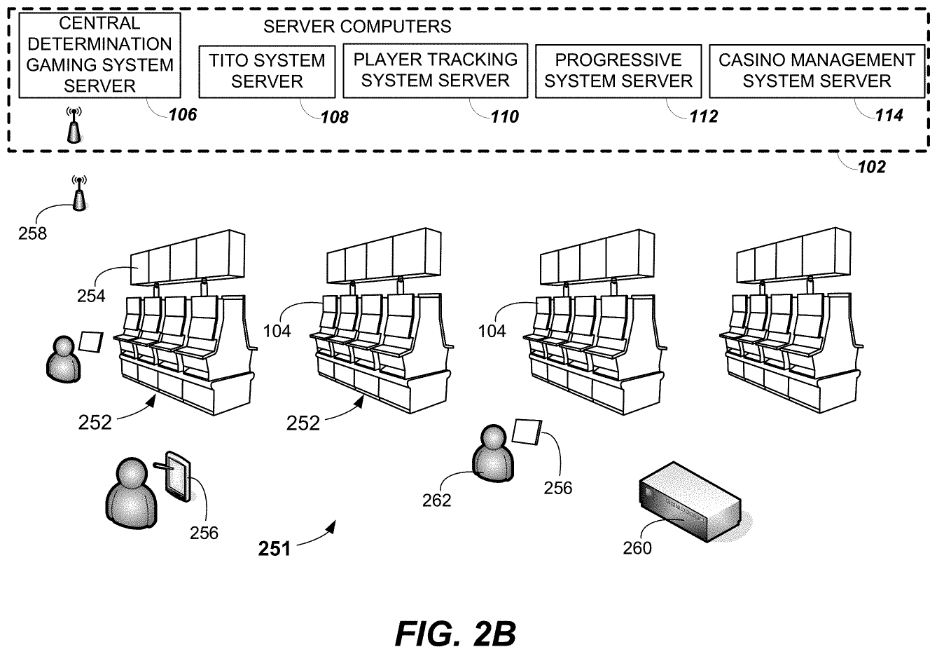

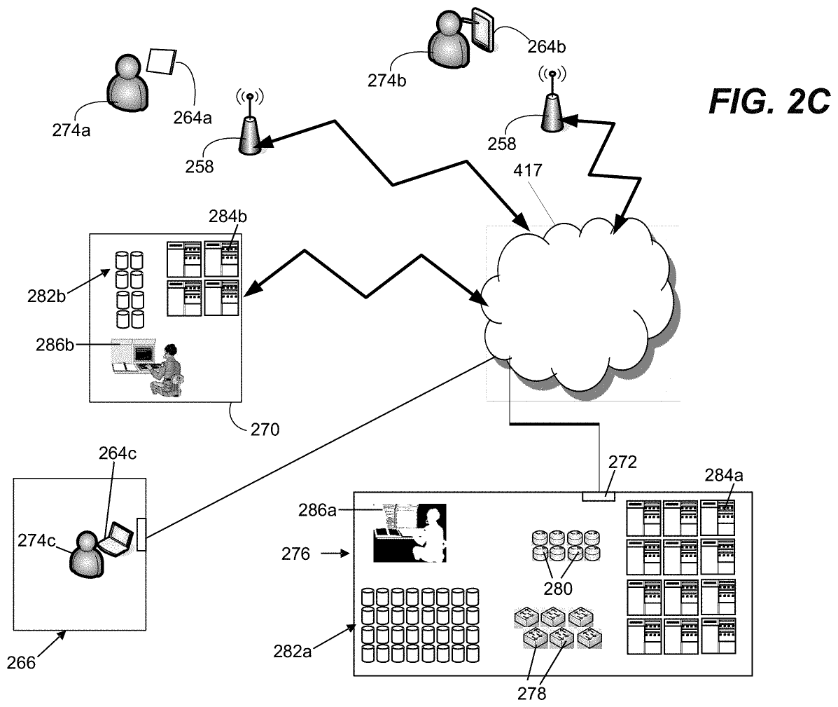

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

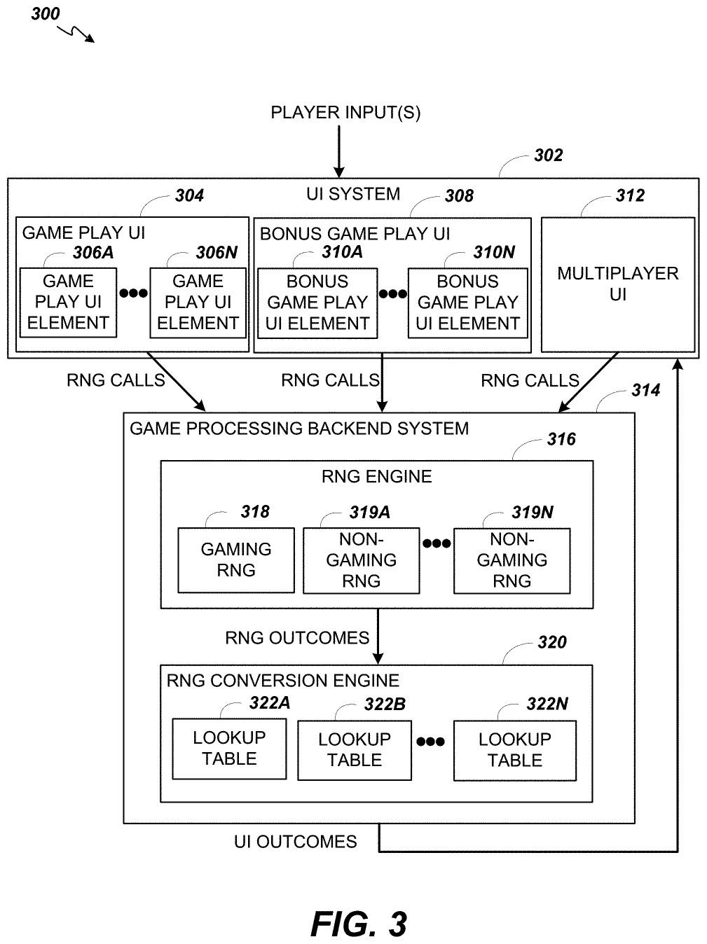

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

In the example embodiment, and as used herein, terms and phrases such as “progressive jackpot,” “progressive jackpot award,” and/or simply “progressive” may refer to an award that is generated or funded from a plurality of networked gaming devices 104A-104X. For example, as described herein, a progressive jackpot may be increased based upon wagers occurring on one or more gaming devices 104A-104X, such as those networked in a “bank” or collection of such devices on a casino floor.

In some embodiments, local-area progressive jackpots may be implemented, which may receive contributions from only a small number of gaming devices 104A-104X, such as those located in a given physical space or area, such as within a bank or other collection of gaming devices 104A-104X. Although local-area progressives are generally described herein, in some implementations, so-called wide-area progressive jackpots may be implemented, which may receive contributions from gaming devices 104A-104X at any location within a given casino and/or, in some embodiments, from gaming devices 104A-104X at different casinos.

Moreover, in some embodiments, a plurality of progressive jackpots may be provided, and one or more jackpots may be variously funded, such as at different rates and/or in different amounts in response to player wagers, and the like. It will also be appreciated that a plurality of progressive jackpots may be organized in one or more tiers and/or otherwise hierarchically, such as from a smallest progressive to a largest progressive, from a largest progressive jackpot to a smallest progressive jackpot, and the like.

In at least some embodiments, a progressive jackpot award may increase from a base value, which may be preset, to any value greater than the base value. In some embodiments, a progressive jackpot award may increase from the base value in increments, such as in increments of fractions of a cent, cents, fractions of a dollar, dollars, and the like. In various embodiments, jackpot increments may be based, at least in part, on player wager values. For example, as one or more players place larger wager amounts during a base and/or bonus game, one or more progressive jackpots may be increased or funded in larger increments and/or, as described in greater detail herein, in more rapidly accumulating increments.

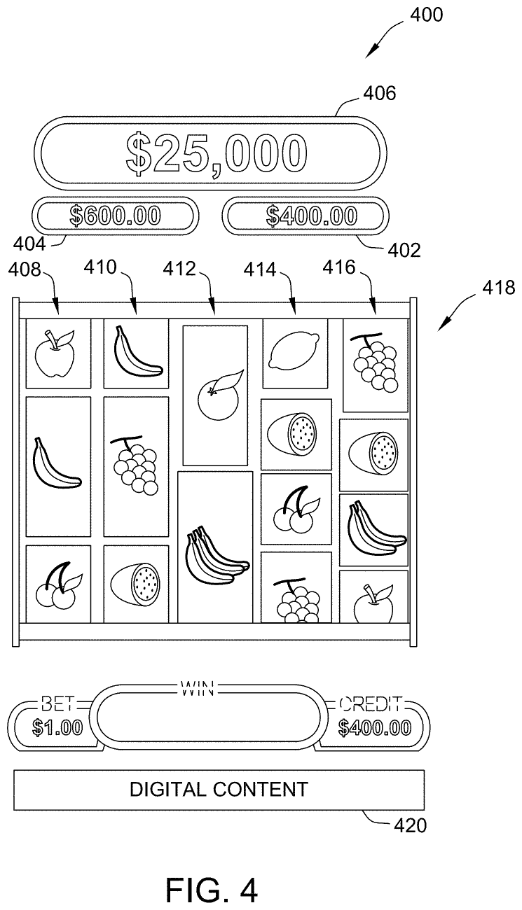

FIG. 4 is a diagram of an example embodiment of a wagering game 400, in which a plurality of progressive jackpots, such as a first progressive jackpot 402, a second progressive jackpot 404, and a third progressive jackpot 406 are shown. Although three progressive jackpots 402-406 are shown, it will be appreciated that any suitable number of progressive jackpots may be implemented.

In the example embodiment, wagering game 400 may also include a plurality of reels, such as a first reel 408, a second reel 410, a third reel 412, a fourth reel 414, and a fifth reel 416. Although five reels 408-416 are shown and described, it will be appreciated that any suitable number of reels may be implemented. For example, in some embodiments, wagering game 400 may include three reels. In other embodiments, wagering game may include four reels. In still other embodiments, wagering game 400 may include any number of reels, such as less than three reels, greater than five reels, and the like.

In the example embodiment, reels 408-416 may define a matrix 418 of symbol positions, each of which may, as shown, include a symbol. More particularly, reels 408-416 may be simulated, such as by processor 204, to spin and stop, and in response to stopping, a symbol may be displayed in each corresponding symbol position of matrix 418.

As described herein, progressive jackpots 402-406 may be funded in a variety of ways. For example, in some embodiments, jackpots 402-406 may be funded in response to, and based upon, a player wager. More particularly, in at least some implementations, jackpots 402-406 may be funded each time a player places a wager using a percentage of the wager (e.g., 2%, 3%, 4%, 5%, etc.). For example, if a player places a wager of $1.00, one or more percentages of the wager may be allocated to one or more of the jackpots 402-406 (e.g., 3% to each of the jackpots 402-406, 3% to fewer than all of the jackpots 402-406, such as only to the jackpots 402-406 the player is eligible to be awarded based on the wager amount, and the like).

In addition to funding one or more jackpots 402-406 at a percentage of each wager, as described above, in some embodiments, at least a portion of each wager may be allocated to a temporary holding account. For example, a portion of the wager percentage allocated to one or more jackpots 402-406 (e.g., 0.25%, 0.5%, etc.) may be added to the temporary holding account, and the remaining portion of the wager percentage may, as described herein, be used to fund one or more jackpots 402-406.

During play of wagering game 400, each time the player places a wager, one or more of jackpots 402-406 may be increased, such as based on the percentage of the player's wager (e.g., for a $1.00 wager, 3% or $0.03, may be added to one or more jackpots 402-406). It will therefore be appreciated that wagering activity by one or more players results in incremental increases to one or more jackpots 402-406.

In addition, as players make larger wagers, it will be appreciated that the percentage of each (larger) wager is also larger, resulting in more rapidly accumulating jackpots 402-406. Likewise, when a network of progressive gaming devices 104A-104X is being played by a large number of players, the progressive jackpots 402-406 associated with the network or bank of gaming devices 104A-104X may also increase more rapidly.

On the other hand, however, when wagering activity is light (e.g., at late night or early morning, etc.), progressive jackpots 402-406 may not be incremented rapidly, or in some cases, at all. To prevent the progressive jackpots 402-406 from stalling (e.g., from not increasing or increasing slowly), in at least some embodiments, funds from the temporary holding account may be added to one or more jackpots 402-406, such as in increments, to increase jackpots 402-406 in the absence of sufficient wagering activity.

As described herein, however, these types of funding approaches by themselves for progressive jackpots, using relatively small percentages of wagers and/or from a temporary holding account during periods of low activity, can be viewed negatively by players, because, for example, these progressive jackpots 402-406 are only increased slowly and in relatively small increments. To alleviate these and other problems, in at least some embodiments of the present disclosure, jackpots 402-406 may also be funded in a variety of other ways, such as, for example, based upon and/or in response to player viewing of digital content in real-time during gameplay and/or in an offline mode, such as prior to a gaming session and/or following a gaming session.

More particularly, in at least some embodiments of the present discloser, one or more players may be offered an increased rate of jackpot increase in exchange for viewing digital content. In some embodiments, digital content may include, but is not limited to, advertisements, marketing materials, and/or any other digital content that may be delivered digitally via gaming devices 104A-104X.

As shown in FIG. 4, digital content may be displayed in a digital content display area 420 (or “content area” 420). In some embodiments, content area 420 is positioned on main display 128. In some embodiments, content area 420 is positioned on button deck 120. In some embodiments, content area 420 is located on a mobile device, such as a smartphone or tablet, of a player. Likewise, in some embodiments, multiple content areas 420 may be displayed, such as on any of main display 128, button deck 120, and/or a player mobile device.

In some embodiments, networked gaming devices 104A-104X may be in communication with a mobile device (e.g., a smartphone or tablet), and may be configured to cause the mobile device to display digital content. For example, mobile device may run a mobile application (“app”), and content data may be transmitted (e.g., by networked gaming devices 104A-104X and/or server computers 102) to the mobile device (e.g., via a Bluetooth®, WiFi®, cellular, or other wireless connection). This content data may be configured to cause the mobile device to display the digital content through the mobile app. Alternatively, digital content may be sent to the mobile device via text messages, emails, or other digital messages. For example, a loyalty account associated with an active player may include information such as a phone number or email address of the active player, and text messages and/or emails including the digital content may be sent to the phone number and/or email address associated with the active player.

In some embodiments, the digital content may be displayed (e.g., in content area 420) concurrently with gameplay. For example, text, images, and/or video may be displayed (e.g., periodically or continuously) in content area 420, and the player may access normal gameplay functions while the digital content is being displayed. In some such embodiments, the digital content may be integrated into the game itself as a part of gameplay. Alternatively, in some embodiments, the player may not be able to access gameplay while the digital content is being displayed. For example, the digital content may be displayed for a predetermined period of time (e.g., five seconds), after which gameplay may resume. In embodiments in which the digital content is displayed via the mobile app, the content may be displayed, for example, for a predetermined period of time, upon the player opening the mobile app and/or when certain features within the mobile app are accessed.

Accordingly, in at least one example embodiment, a player may be offered an increased rate of jackpot incrementation or jackpot increase (e.g., on of one more jackpots 402-406) in exchange for and/or on the condition that the player agrees to view digital content, such as an advertisement, during game play or at some time before or after game play. In some embodiments, the digital content may be provided by a casino, and when a player views the digital content, the casino may provide the funds needed to increase jackpots 402-406 at a faster rate.

Thus, the gaming system described herein includes a display device, and a processor that is configured to control the display device to display digital content. In response to controlling the display device to display the digital content, the processor is configured to increase the incremental value associated with a progressive jackpot (e.g., 3%) from a first incremental amount (e.g., 3% or $0.03 for $1.00 wager) to a second incremental amount (e.g., 6% or $0.06 for $1.00 wager). The processor is also configured to control the progressive meter to display at least one increase of the progressive jackpot by the second incremental amount, such that a running total amount of the progressive jackpot increases more rapidly in response to the digital content being displayed.

However, in at least some embodiments, a third-party provider of digital content, such as a retailer or another merchant, may provide the funds necessary to increase jackpots 402-406 at the faster rate. In some embodiments, third-party providers may be charged by a casino or another gaming establishment based upon click-through by players. For example, as a particular advertisement or other piece of digital content is clicked-on or otherwise selected by players at an increasing rate and/or in increasing quantity, the funds that the third-party content provider may be required to pay (e.g., to increase jackpots 402-406) may be increased as well. In other embodiments, however, the rate of click-through may not affect pricing. In some embodiments, a third-party provider of digital content may be selected based on data, such as browsing history data, associated with the player.

To increase the rate of jackpot incrementation, in at least some embodiments, an additional amount may be added to the base rate of jackpot incrementation. For example, if the base rate is 3% of player wagers, as described above, an additional percentage, such as an additional 3%, may be added to the rate of incrementation, such that the rate at which jackpots 402-406 increase in response to player wager effectively appears to double in response to viewing of digital content. The additional percentage may, as described, be funded from funds provided, such as to the temporary holding account and/or another secondary funding account, by a third-party content provider and/or by the casino.

In some embodiments, processor 204, progressive system controller 112, and/or another progressive system controller (either external or on-site) may therefore determine an additional amount to add to one or more jackpots 402-406 dynamically and in real-time, such as based upon a base rate of increase (e.g., 3%) and a player wager. To illustrate, if a player wagers $1.00, processor 204 may calculate a first jackpot increment of $0.03. Processor 204 may, in addition, calculate a second rate of jackpot increment based on the first rate, such as for example, an additional 3% or $0.03, for a total jackpot increment, per every $1.00 wager, of $0.06. It will be appreciated however, that if a player switches a wager amount to a different value, such as from $1.00 to $2.00, processor 204 may respond on the fly to calculate new rates of jackpot increment, both for the base rate as well as the additional rate contributed from the secondary funding account.

At least one technical improvement arising as a result is that the rate of increase of one or more progressive jackpots 402-406 can be highly variable and/or unpredictable, both as a result of the dependency, in at least some embodiments, on wager amounts, but also as a result of the dependency on and increased funding in response to player viewing of digital content.

In addition to these features, in at least some embodiments, one or more secondary funding accounts may be maintained for one or more of a plurality of third-party content providers. For example, a memory device, such as a progressive system server 112, may include a database of funding accounts for one or more of a plurality of third-party content providers. These may be stored in association with one or more temporary holding accounts, as described herein, as well as one or more progressive jackpot 402-406 meters or amounts.

To illustrate, in at least one embodiment, a first funding account may be stored in association with a first merchant (“Merchant A”), a second funding account may be stored in association with a second merchant (“Merchant B”), and so on. When a player views digital content provided and/or funded by Merchant A, funds from the first funding account may be used to increase one or more jackpots 402-406. Likewise, when a player views digital content provided and/or funded by Merchant B, funds from the second funding account may be applied to increase jackpots 402-406, and the like.

At least one technical improvement embodied by these features is that a unique database structure may be created and utilized to store the funds supplied by a plurality of merchants. When a particular merchant's digital content is provided to a player, the funding account associated with that merchant may be debited, and the database record updated, to reflect that the merchant's funding account was used to add an increment (or increments) to at least one progressive jackpot 402-406. These records may be maintained dynamically and in real-time, and a variety of actions may be taken by the system in response to certain conditions being met. For example, as a merchant's funding account is debited over time, the account may reach a threshold minimum value. When this occurs, the system may send an alert or message to the merchant (e.g., via email) notifying the merchant that the funding account is running low. A merchant portal may also be provided that allows merchants to log in and add funds to respective funding accounts (e.g., from a merchant digital wallet, via wire transfer, and the like).

In addition to increasing a rate of increment of one or more jackpots 402-406, in at least some embodiments, a rate of increment may also be increased for a period of time. For example, as described herein, the rate of increment may be increased from a first percentage to a second percentage on a wager-by-wager basis and/or in some embodiments, for a predefined period of time, such as 5 seconds, 10 seconds, 30 seconds, 1 minute, and the like. Likewise, a rate of increment may be increased for a predefined number of spins and/or a predefined number of wagers, such as for example, for 10 spins and the like.

In some embodiments, an option may be provided to a player to opt-in and/or opt-out of digital content. For example, prior to viewing digital content as well as during the viewing of such content, an option may be provided that a player may select to disable digital content and/or to view (or continue viewing) digital content. As a result, players who do not wish to view digital content may opt-out, while players who wish to view digital content may opt-in.

For example, in some embodiments, gaming devices 104A-104X may include a button and/or menu option that may enable players to opt-in or opt-out of digital content. In some embodiments, when play is initiated, gaming devices 104A-104X may prompt the player to opt-in or opt-out of digital content. Such prompts may be displayed periodically throughout gameplay (e.g., recurring after a predetermined time period and/or number of game instances). In some embodiments, a player loyalty account may include settings as to whether the player has opted-in to viewing digital content, and gaming devices 104A-104X may display digital content based on these settings. In some embodiments, gaming devices 104A-104X may display digital content by default without prompting or receiving an opt-in from the player.

In some embodiments, because progressive jackpots 402-406 are linked or networked to a plurality of gaming devices 104A-104X (e.g., as a local area bank of progressives), and because not every player may opt-in to view digital content, players who have opted in to view digital content may feel that the benefit of the increase in contributions to jackpots 402-406 resulting from their digital content viewing is unfairly shared with players who have opted out (or not opted in).

To address this concern, in at least some embodiments, players may be provided personal progressive jackpots (not shown), which can only be won by individual players. For example, a personal progressive jackpot (or plurality of personal jackpots) may be linked to a player account and available only to a particular player. In addition, the personal progressive jackpot may only receive funding contributions from a single player, such as in response to wagers placed by the single player over a period of time, and the like. The personal progressive jackpot may be awarded to the player in response to the player being awarded the primary progressive jackpot, such that the personal progressive jackpot may be displayed as a bonus awarded on top of the primary progressive jackpot, thus incentivizing players to opt-in to viewing digital content. In some embodiments, gaming devices 104A-104X and/or the mobile app may display a running accumulated amount of the personal progressive jackpot, indicating the amount “earned” for the personal progressive jackpot by the player for opting-in to viewing digital content.

In these embodiments, a player's digital content viewing may still result in an increased increment, or increased rate of increment, to one or more personal progressive jackpots, as described herein. However, because the jackpots may be linked to a player account and “personal” to a given player, the concern that a player's digital content viewing may result in an increase to a progressive jackpot 402-406 that is ultimately won by another player can be alleviated.

In addition, in at least some embodiments, an increased rate of jackpot funding may be split or otherwise allocated between one or more jackpots 402-406 as well as one or more other awards or award programs, such as a player loyalty account. For example, a first portion of an increased jackpot increment may be provided to the jackpot 402-406, as described herein. However, in at least some embodiments, a second portion of an increased jackpot increment may also be split off from the first portion and, rather than adding the second portion to a jackpot 402-406, the second portion may be added to player loyalty account, such as in the form of credits, loyalty points, a slowly incrementing and/or running cash award, and the like. In one example, if a jackpot 402-406 is funded at a base percentage of 3%, and an increased jackpot increment of 7% is added in response to digital content viewing, a first portion (e.g., 2%) of the increased 7% may be provided to one or more jackpots 402-406, as described herein, while a second portion (e.g., 5% may be added to a player's loyalty account). As a result, the first portion and the second portion need not be equal, although in some cases, an increased jackpot increment may be evenly split between one or more jackpots 402-406 and a loyalty account.

As described above, these percentages may, in at least some embodiments, be based upon a wager amount, such that increased rates of contribution may vary dynamically and in real-time from wager to wager. In some embodiments, the contribution percentages described herein may be adjusted in intervals, such as once an hour, based on an average wager over the course of the interval. Likewise, in some embodiments, for a given bank of gaming devices 104A-104X, an increased contribution may be based upon an instantaneous and/or average wager of all players at the bank. Further, in at least some embodiments, the increased funding contribution may not be based upon a wager percentage. Rather, in some embodiments, increased jackpot funding contributions may be predetermined and/or manually specified, such as by a casino operator. In some embodiments, increased funding contributions may also be bulk contributions that are designed to cause one or more jackpots 402-406 to increase rapidly.

In some embodiments, one or more video or image recording devices, such as one or more cameras (not shown), may be included in gaming devices 104A-104X. The image recording devices may be used, in some embodiments, to record player reactions to increased jackpot contributions and jackpot awards, such as player excitement. In some embodiments, recorded player reactions may be provided to the player in association with an option to share the player reaction (e.g., on a social media account) with one or more followers, friends, and the like. In addition, in some embodiments, the image recording devices may be used to monitor digital content viewing. For example, in at least one embodiment, it may be desirable to determine that a player is viewing digital content without requiring an explicit opt-in and/or to periodically confirm that a player who has opted-in to view digital content is viewing the content (e.g., by monitoring the player's eyes, head position or orientation, and the like).

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a display device; and
a processor configured to execute instructions stored in a memory device, which when executed, cause the processor to at least:
control the display device to display digital content;
in response to controlling the display device to display the digital content, increase an incremental value associated with a progressive jackpot from a first incremental amount to a second incremental amount; and
control the display device to display a meter indicating at least one increase of the progressive jackpot by the second incremental amount, such that a running total amount of the progressive jackpot increases more rapidly in response to the digital content being displayed.

2. The system of claim 1, wherein the processor is further configured to increase the running total amount of the progressive jackpot by the incremental value in response to a player wager.

3. The system of claim 2, wherein the incremental value is defined as a percentage of the player wager.

4. The system of claim 1, wherein the processor is further configured to transfer at least a portion of the incremental value to a temporary holding account.

5. The system of claim 1, wherein the processor is further configured to:
control the display device to display a user interface, the user interface including a digital content display area; and
control the display device to display digital content in the digital content display area.

6. The system of claim 1, wherein the processor is further configured to, in response to the progressive jackpot being incremented, transfer a difference between the second incremental amount and the first incremental amount from a third-party funding account to the progressive jackpot.

7. The system of claim 6, wherein the third-party funding account is associated with first third-party content provider of a plurality of third-party content providers, and wherein the processor is configured to:
in response to controlling the display device to display the digital content, identify the first third-party content provider as being associated with the digital content;
perform a lookup in a database to identify the third-party funding account associated with the first third-party content provider; and
in response to identifying the third-party funding account, transfer the difference from the third-party funding account to the progressive jackpot.

8. The system of claim 1, wherein the processor is further configured to increase the incremental value associated with the progressive jackpot from the first incremental amount to the second incremental amount for a predefined period of time.

9. The system of claim 1, wherein the processor is further configured to:
receive a selection from a player to opt-in to viewing the digital content; and
in response to receiving the selection to opt-in, control the display device to display the digital content.

10. The system of claim 1, wherein the processor is further configured to transfer at least a portion of the incremental value is to a personal jackpot associated with a player.

11. The system of claim 10, wherein the portion transferred to the personal jackpot includes a difference between the second incremental amount and the first incremental amount.

12. The system of claim 1, further comprising an image recording device in communication with the processor, wherein the processor is further configured to:
monitor, using the image recording device, viewing of the digital content by a player to determine the player is viewing the digital content; and
in response to determining the player is viewing the digital content, increase the incremental value associated with the progressive jackpot from the first incremental amount to the second incremental amount.

13. The system of claim 1, wherein the processor is further configured to transmit content data to a mobile device, the content data configured to cause the mobile device to display the digital content.

14. A method for increasing a progressive jackpot, the method comprising:
controlling, by a processor, a display device to display digital content;
in response to controlling the display device to display the digital content, increasing, by the processor, an incremental value associated with a progressive jackpot from a first incremental amount to a second incremental amount; and
controlling, by the processor, the display device to display a meter indicating at least one increase of the progressive jackpot by the second incremental amount, such that a running total amount of the progressive jackpot increases more rapidly in response to the digital content being displayed.

15. The method of claim 14, further comprising:
controlling, by the processor, the display device to display a user interface, the user interface including a digital content display area; and
controlling, by the processor, the display device to display digital content in the digital content display area.

16. The method of claim 14, further comprising, in response to the progressive jackpot being incremented, transferring, by the processor, a difference between the second incremental amount and the first incremental amount from a third-party funding account to the progressive jackpot.

17. The method of claim 16, wherein the third-party funding account is associated with first third-party content provider of a plurality of third-party content providers, and wherein the method further comprises:
in response to controlling the display device to display the digital content, identifying, by the processor, the first third-party content provider as being associated with the digital content;
performing, by the processor, a lookup in a database to identify the third-party funding account associated with the first third-party content provider; and
in response to identifying the third-party funding account, transferring, by the processor, the difference from the third-party funding account to the progressive jackpot.

18. The method of claim 14, further comprising:
receiving, by the processor, a selection from a player to opt-in to viewing the digital content; and
in response to receiving the selection to opt-in, controlling, by the processor, the display device to display the digital content.

19. The method of claim 14, further comprising transmitting, by the processor, content data to a mobile device, the content data configured to cause the mobile device to display the digital content.

20. At least one non-transitory computer-readable media having computer-executable instructions embodied thereon, wherein when executed by a processor, the computer-executable instructions cause the processor to at least:
control a display device to display digital content;
in response to controlling the display device to display the digital content, increase an incremental value associated with a progressive jackpot from a first incremental amount to a second incremental amount; and
control the display device to display a meter indicating at least one increase of the progressive jackpot by the second incremental amount, such that a running total amount of the progressive jackpot increases more rapidly in response to the digital content being displayed.
